(19) United States
(12) Patent Application Publication
(10) Pub. No.: US 2006/0006075 A1
(43) Pub. Date: Jan. 12, 2006

(54) Storage solution for pH glass electrode

(75) Inventor: Shane O'Neill, Urdorf (CH)

Correspondence Address: SHOEMAKER AND MATTARE, LTD, 10 POST OFFICE ROAD - SUITE 110, SILVER SPRING, MD, 20910, US

(73) Assignee: Metroglas AG, Affoltern (CH)

(21) Appl. No.: 11/175,387

(22) Filed: Jul. 7, 2005

(30) Foreign Application Priority Data
Jul. 8, 2004 (EP) 04016086.3

(51) Int. Cl. G01N 27/26

(52) U.S. Cl. 205/787.5; 204/420

(57) ABSTRACT

The invention relates to a process for storage of a pH glass electrode (1), characterized in that at least the swelling layer (2) of the pH glass electrode (1) is stored in a storage solution (3) which is essentially free of alkali-metal ions. Preferably the storage solution (3) is an ammonium chloride or ammonium nitrate solution (NH₄Cl solution or a NH₄NO₃ solution), or an alkaline earth salt solution, especially an alkaline earth chloride solution, preferably a magnesium chloride solution (MgCl₂ solution).

### BACKGROUND OF THE INVENTION

The invention relates to a process for storage of a pH glass electrode, the use of an essentially alkali metal ion-free solution as the storage solution for such a pH glass electrode, and a system comprising a pH glass electrode and a storage solution as described below.

Often pH glass electrodes are used to measure pH values of aqueous media. These pH glass electrodes have a generally hemispherical membrane of pH glass with a silicate skeleton which forms a thin swelling layer upon contact with aqueous media. Mainly lithium silicate glasses are used. The wall of the pH glass membrane is generally 0.2 mm to 0.5 mm thick, conversely the swelling layer in the contact area to the aqueous medium is generally only about 0.1 micron thick.

On the inside of the pH glass membrane is a buffer solution with a known pH value; the outside of the pH glass membrane is brought into contact with the sample solution which is to be measured. On the inner and outer boundary surface between the pH glass membrane and the solutions, potential differences form which depend on the respective pH value of the solutions and which are measured with an inner reference electrode and an outer reference electrode. This voltage is proportional to the pH of the analysis solution.

In the indicated swelling layer the glass structure is softened; the swelling layer is thus accessible to penetrating ions, especially cations. In their composition pH glasses are optimized to as much as possible only protons being able to penetrate into the swelling layer. The swelling process is slow, but continuously progressive so that other ions, such as for example sodium and potassium ions, can also penetrate into the swelling layer. At higher alkali concentrations this leads to a so-called “alkali error”, especially at low proton concentrations of the sample which is to be measured. If a pH glass electrode is stored for a longer time in more highly concentrated alkali salt solutions, for example sodium or potassium ions penetrate into the swelling layer. In a pH measurement they must first be displaced again from the swelling layer; this leads to a prolonged response time of the pH glass electrode. Intercalation of foreign ions is reversible, but especially sodium and potassium ions can be very stably incorporated into the silicate skeletons.

Generally silver/silver chloride electrodes (Ag/AgCl electrodes) or mercury-mercuric chloride electrodes (Hg2Cl₂ electrodes) are used as the inner and outer reference electrodes. Here the metal is joined to its poorly soluble chloride (as a coating on the metal) which in turn is generally immersed into a saturated potassium chloride solution (KCl solution). This potassium chloride solution is joined via a diaphragm to the test solution (in the case of the outer reference electrodes) or to the buffer solution with a known pH value (in the case of the inner reference electrode).

The swelling layer must be kept continuously wet so that it remains intact. Therefore the pH glass electrode is stored in a storage solution, especially when not in use for a long time. Generally for this purpose likewise a potassium chloride solution (KCl solution) is used as a result of the very small diffusion potentials on the diaphragm and the low cost of KCl. Moreover penetration of the potassium chloride solution into the reference system of the pH glass electrode via the outer reference electrode cannot lead to a potential shift, since generally the potassium chloride solution is also used as an electrolyte in the reference system.

The response times of the pH glass electrode which are prolonged especially after longer storage are the disadvantages in the known storage solutions, especially the potassium chloride solution.

### SUMMARY OF THE INVENTION

Therefore the object of the invention is to avoid the disadvantages of what is known, especially to make available a storage solution for a pH glass electrode and a system comprising a pH glass electrode and a storage solution which does not significantly degrade the response times of the pH glass electrode especially even after longer storage, especially keeps them as constant as possible. Moreover a potential shift relative to the electrolyte especially in the outer reference electrode is to be avoided as much as possible and the corrosion of the glass and progression of swelling of the swelling layer are to be kept as small as possible. In addition, the steepness of the calibration lines is not to be affected.

This object is achieved by a process for storage of a pH glass electrode, the use of an essentially alkali metal ion-free solution as the storage solution for such a pH glass electrode, and a system comprising a pH glass electrode and a storage solution as described below.

An “essentially alkali metal ion-free solution” is defined here and below as especially solutions which contain alkali metal ions in a concentration of less than 0.5 mole/L. Preferably such a solution is free of alkali metal ions; in particular brief, higher concentrations of alkali metal ions of for example up to 0.5 mole/L are however tolerable.

The process for storing a pH glass electrode is characterized in that at least the swelling layer of the pH glass electrode is stored in a storage solution which is essentially free of alkali-metal ions. In abandoning the potassium chloride solution (KCl solution) which is preferred in the prior art, it was surprisingly found that the response time can be essentially maintained even after longer storage especially by an ammonium salt solution such as for example an ammonium chloride solution (NH₄Cl solution) or an ammonium nitrate solution (NH₄NO₃ solution); or an alkaline earth salt solution, typically a magnesium salt solution such as for example a magnesium chloride solution (MgCl₂ solution) or a magnesium nitrate solution (Mg(NO₃)₂ solution) as a storage solution. This is especially surprising for ammonium salt solutions since the ammonium ion and the potassium ions are otherwise very similar (ion size, etc.), but apparently behave differently with respect to integration into the silicate skeleton of a swelling layer. Moreover especially a 3M ammonium chloride solution has the added advantage that the solution has a pH of 4.4. This is within the especially preferred pH range from pH 3 to pH 5 in which corrosion of the glass is least and the progression of the swelling process is slowest (Z. Boksay, G. Bouquet, “The pH dependence and an electrochemical interpretation of the dissolution rate of a silicate glass”, Phys. Chem. Glasses 21 (1980)).

According to one preferred embodiment at least the swelling layer of a combined pH glass electrode is stored in an essentially alkali metal-free ammonium chloride solution, or at least the swelling layer of a separate pH glass electrode is stored in an essentially alkali metal-free magnesium chloride solution.

It was found that with an alkaline earth salt solution, especially an alkaline earth chloride solution, preferably a magnesium chloride solution, conditioning of the swelling layer can be induced which even partially surpasses the action of an ammonium salt solution, especially an ammonium chloride solution. But when the magnesium chloride solution penetrates into the reference system, especially via the outer reference electrode with a potassium chloride electrolyte, an undesirable potential shift and a change in the gradient of the calibration lines result; these problems do not occur when an ammonium salt solution is used, especially an ammonium chloride solution. It is therefore preferred that the pH glass electrode be stored with the swelling layer in an alkaline earth solution, especially an alkaline earth chloride solution, preferably a magnesium chloride solution, if there is an outer reference electrode which is physically separate (or separable for purposes of storage) from the glass electrode. An undesirable potential shift and change in the gradient of the calibration lines can thus be avoided since penetration of the storage solution into the reference system is not possible due to the physical separation of the outer reference electrode.

Here and below a “separate” pH glass electrode is defined as a pH glass electrode in which the outer reference electrode is located physically separate from the actual glass electrode or is located separably for purposes of storage. Conversely a “combined” pH glass electrode is defined as a pH glass electrode in which the outer reference electrode is physically connected to the actual glass electrode and is not made to be easily separable from it for storage.

In particular, with an ammonium salt solution, especially an ammonium chloride solution as the storage solution, an outstanding compromise has been found with which the response time is maintained even after longer storage in the storage solution and with which moreover no potential shift occurs relative to the popular reference electrolyte, 3M potassium chloride, when the storage solution penetrates into the reference system via the outer reference electrode.

The anions, especially the chloride ion and nitrate ion concentration of the storage solution should preferably be chosen such that it corresponds to the chloride ion concentration of the reference electrolyte±roughly 50%. The preferred concentration of the ammonium salt solution, especially an ammonium chloride or ammonium nitrate solution, c(NH₄Cl) or c(NH₄NO₃), is typically between 0.1 mole/liter and saturated, preferably roughly 3 mole/l. The preferred concentration of the alkaline earth salt solution, especially an alkaline earth chloride or alkaline earth nitrate solution, for example a magnesium chloride or magnesium nitrate solution c(MgCl₂) or c(Mg(NO₃)₂) is typically between 0.05 mole/l and saturated, preferably roughly 1.5 mole/l.

The invention furthermore relates to use of an essentially alkali metal ion-free solution, especially an ammonium chloride solution (NH₄Cl solution) or magnesium chloride solution (MgCl₂ solution) as the storage solution for such a pH glass electrode,

Here it is especially preferred that an essentially alkali metal ion-free ammonium salt solution, especially an ammonium chloride or ammonium nitrate solution, especially with a concentration of typically between 0.1 mole/liter and saturated, preferably of roughly 3 mole/l, be used as the storage solution for a combined pH glass electrode, conversely for separate pH glass electrodes preferably an essentially alkali metal ion-free alkaline earth salt solution, especially an alkaline earth chloride solution, preferably a magnesium chloride solution, especially with a concentration c(MgCl₂) of typically between 0.05 mole/l and saturated, preferably roughly 1.5 mole/l, be used as the storage solution. Of course it is likewise possible within the framework of the invention to store separate pH glass electrodes in an especially alkali metal ion-free ammonium salt solution, especially with a concentration of 3 mole/l.

The invention furthermore relates to a system comprising the following:
a pH glass electrode; and
a storage solution which is essentially free of alkali metal ions, especially an ammonium chloride or ammonium nitrate solution (NH₄Cl solution or a NH₄NO₃ solution) or an alkaline earth salt solution, especially an alkaline earth chloride solution, preferably a magnesium chloride solution (MgCl, solution) or a magnesium nitrate solution (Mg(NO₃)₂ solution); or the parent substance(s) for producing such a storage solution, especially ammonium chloride (NH₄Cl), ammonium nitrate (NH₄NO₃), an alkaline earth chloride or alkaline earth nitrate, especially magnesium chloride (MgCl,) or magnesium nitrate (Mg(NO₃)₂).

The storage solution of course however can be made available ready-to-use, but also for example as a solution which is still to be diluted. Of course, simply making available the parent substance(s) is possible, for example therefore of solid ammonium chloride (NH₄Cl) or solid magnesium chloride (MgCl₂) or as hexahydrate MgCl₂*6 H₂O.

It is especially preferred within the framework of the invention not to change the configuration of existing pH glass electrodes, especially therefore the reference electrolyte in the reference system. This is accomplished especially by the above described outstanding compatibility for example of a 3M ammonium chloride solution as the storage solution with a 3M potassium chloride solution as the reference electrolyte in the reference system.

### BRIEF DESCRIPTION OF THE DRAWINGS

The invention is explained below using one preferred embodiment without the subject matter of the invention being limited to this embodiment.

FIG. 1 shows a pH glass electrode, schematic operating principle;

FIG. 2 shows a reference electrode, schematic structure;

FIG. 3 shows a combined pH glass electrode, schematic;

FIGS. 4 and 5 show static and dynamic response times of the pH glass electrode depending on storage in three different storage solutions.

### DESCRIPTION OF THE PREFERRED EMBODIMENT(S)

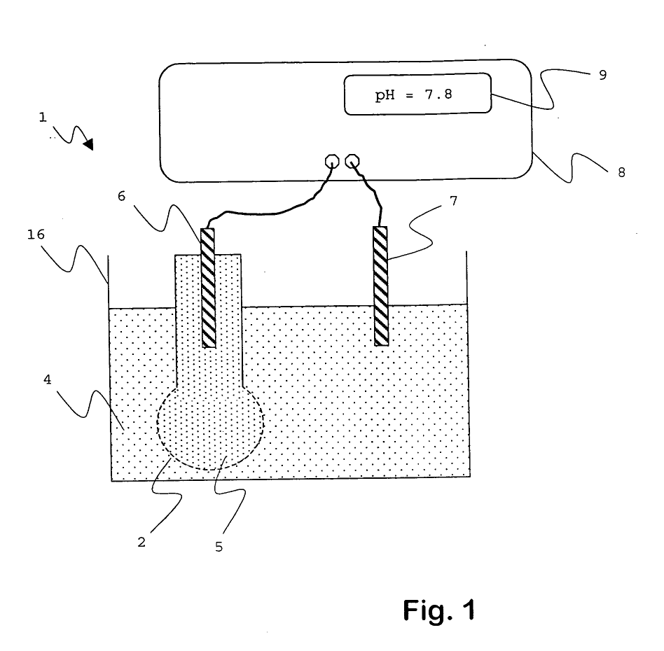

FIG. 1 schematically shows the operating principle of pH glass electrode 1. Such a pH glass electrode has an inner reference electrode 6 and an outer reference electrode 7. The outer reference electrode 7 is in direct contact with an analysis solution 4 which is located in a vessel 16. The inner reference electrode 6 is in contact with a puffer 5 with a known pH. The inner reference electrode 6 is in contact with the analysis solution 4 via a swelling layer 2 in the pH glass electrode 1 and the buffer 5 with a known pH. On the inner and outer boundary surface of the swelling layer 2 a potential difference forms which is proportional to the pH of the analysis solution 4 and which can be measured with the reference electrodes 6 and 7. The measured value is generally output directly on a display 9 of a pH measurement device 8 as the pH value of the analysis solution 4. FIG. 1 shows one embodiment of a pH glass electrode 1 with an outer reference electrode 7 which is physically separate from the rest of the electrode. Of course a combined structure of a pH glass electrode 1 is also possible in which the outer reference electrode 7 is joined or can be joined to the remainder of the pH glass electrode 1.

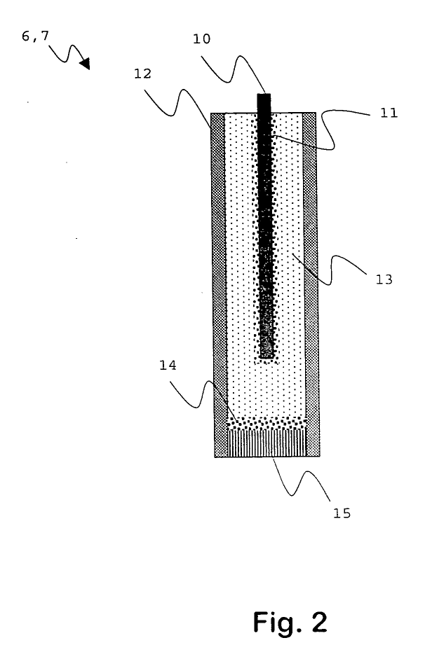

FIG. 2 schematically illustrates the structure of an inner and outer reference electrode 6, 7 which can have the same structure, using an Ag/AgCl electrode. A silver wire 10 is coated with a layer of silver chloride 11. This silver wire 10 is surrounded by a glass wall 12 which is filled with a reference electrolyte 13, generally 3M potassium chloride (KCl). Via a diaphragm (ceramic pin, platinum twist, ground section, hole, etc.) 15 the reference electrode 6, 7 is joined to an analysis solution or a storage solution 3.

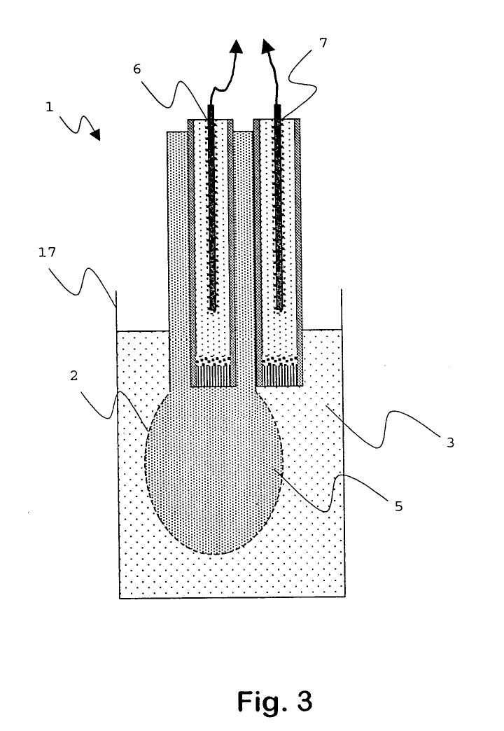

FIG. 3 schematically illustrates a combined pH glass electrode 1, with an inner reference electrode 6 and an outer reference electrode 7. The silver wires of the two reference electrodes 6, 7 can be connected to a pH measurement device 8 (not shown here). The swelling layer 2 of the pH glass electrode must be kept continuously wet so that the swelling layer 2 is kept intact. To do this, at least the swelling layer 2 of the pH glass electrode 1 is stored in a storage solution 3 which is located in a storage container 17; generally the storage container 17 is a cap or the like which can be slipped on. Usually a 3M potassium chloride solution is used at present as a storage solution 3 since it does not cause a potential shift with the reference electrolyte (generally likewise KCl) if the storage solution 3 penetrates into the reference system of the outer reference electrode 7 in the storage of the pH glass electrode 1. Moreover KCl has only a very small diffusion potential on the diaphragm 15 and is moreover very economical.

The disadvantage in the use of KCl as the storage solution 3 is the rather long response times of the pH glass electrode 1, especially after longer storage.

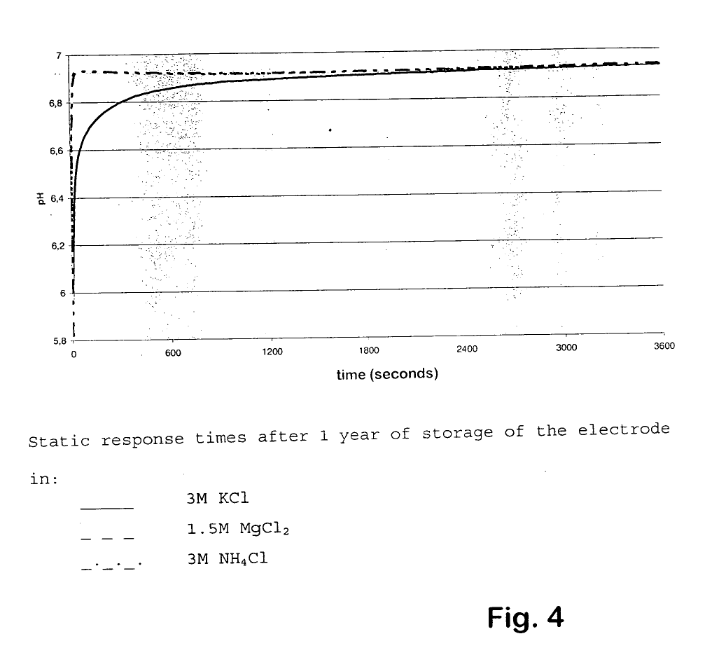

FIG. 4 illustrates the response times of a pH glass electrode 1 in a low-conducting solution after storage in different storage solutions 3 for 1 year at a time. Different lithium silicate glasses were used as the pH glass, of which here one has been selected by way of example. The invention is not to be limited to interaction with special pH glasses. The low-conducting solution is a CO₂-saturated, 0.05 mM sodium hydrogen carbonate solution. According to EN-ISO-10523 such a solution has a pH of 7.00 at 25° C. This solution was used for static response time measurements which were taken by immersing the electrode into the solution. FIG. 4 shows that with a 3M potassium chloride storage solution (solid line) adjustment of a pH of roughly 7 which has been greatly delayed both compared to a 1.5M magnesium chloride storage solution (broken line) and also a 3M ammonium chloride storage solution (dot-dash line) takes place.

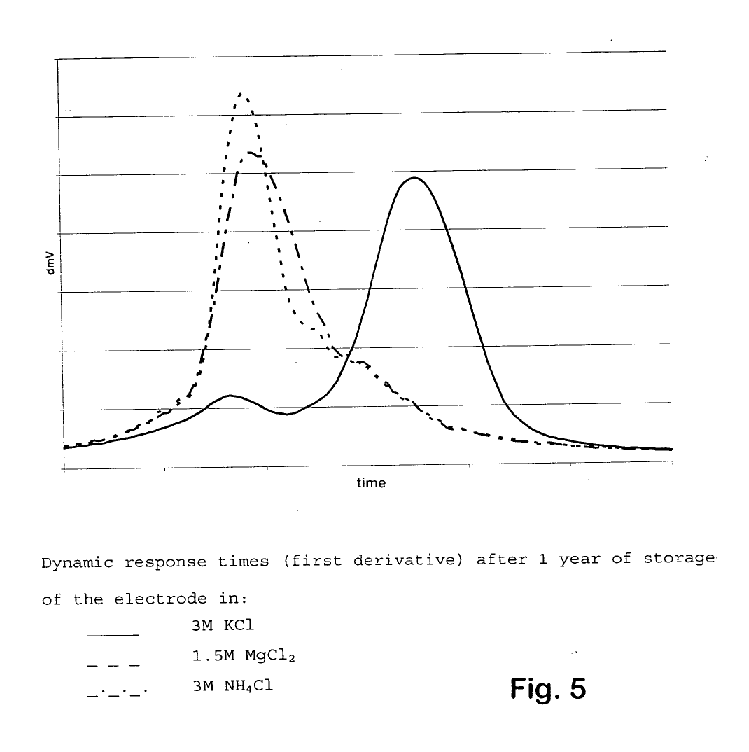

In addition, a 0.14 mM NaOH solution was used as a model solution in order to study the response time during a titration (dynamically) (FIG. 5). It was applied and at a constant metering rate was titrated with an acid, here 0.1 mole/L hydrochloric acid, by means of a computer-controlled, mechanical precision burette. An ideal response time, represented by the first derivative of the titration curve, shows a large peak which is followed by a second, smaller peak. A small peak conversely which is followed by a large peak, illustrate a very poor response time. While storage of the electrode for one year in 3M KCl (solid line) leads to very poor response time (small peak followed by a larger peak), much improved response times are achieved both with 3M NH₄Cl (dot-dash line) and also with 1.5M MgCl₂ (broken line). This emphasizes the outstanding suitability of NH₄Cl and MgCl₂ as storage solutions for pH glass electrodes.

Since when the pH glass electrode is being stored the storage solution can penetrate into the reference system of the outer reference electrode (generally 3M KCl), it was studied whether this leads to a potential shift. To do this various mixtures as a reference electrolyte were added to the outer reference electrode. The results are shown in Table 1.

TABLE 1

| | | | | Zero point |
|---|---|---|---|---|
| | S 4-7-9 (%) | S 4-7 (%) | S 7-9 (%) | (mV) |
| KCl* | 99.10 | 99.27 | 98.80 | −1.00 |
| NH₄Cl* | 99.82 | 99.67 | 100.08 | −1.90 |
| MgCl₂:KCl | 99.60 | 98.54 | 101.42 | −6.20 |
| 1:4* | | | | |
| MgCl₂:KCl | 99.94 | 97.54 | 104.06 | −15.80 |
| 1:1* | | | | |
| MgCl₂* | 99.97 | 96.03 | 106.74 | −25.10 |

All reference electrolytes have a chloride ion concentration of 3 mole/l at exactly pH 7.00. The zero point is given as a millivolt value of the electrode at exactly pH 7.

S 4-7-9: Gradient of the calibration lines, computed from measurements of the calibration buffer, pH 4, pH 7 and pH 9.

S 4-7: Gradient of the calibration lines, computed from measurements of the calibration buffer pH 4 and 7 pH.

S 7-9: Gradient of the calibration lines, computed from measurements of the calibration buffer pH 7 and pH 9.

Table 1 above shows that even with a pure, 3M NH₄Cl solution as the reference electrolyte, outstanding calibration lines and zero point values which are comparable to 3M KCl can be achieved. When using rising portions of MgCl, a potential shift however occurs: The gradients of the calibration lines are unsatisfactory especially for 2-point calibrations and the zero point is greatly shifted. Therefore a MgCl₂ storage solution can be used mainly for separate pH glass electrodes. The NH₄Cl storage solution is conversely equally well suited both for combined and also separate pH glass electrodes.

I claim:

1. Process for storage of a pH glass electrode (1), characterized in that at least the swelling layer (2) of the pH glass electrode (1) is stored in a storage solution (3) which is essentially free of alkali-metal ions.

2. Process as claimed in claim 1, wherein the storage solution (3) is an ammonium chloride solution (NH₄Cl solution); an ammonium nitrate solution (NH₄NO₃ solution) or an alkaline earth salt solution, especially an alkaline earth chloride solution; especially a magnesium salt solution, especially a magnesium chloride solution (MgCl₂ solution).

3. Process for storage of a pH glass electrode (1) as claimed in claim 1, comprising the following steps:
storage of at least the swelling layer (2) of a combined pH glass electrode (1) in an essentially alkali metal-free ammonium chloride or ammonium nitrate solution; or
storage of at least the swelling layer (2) of a separate pH glass electrode (1) in an essentially alkali metal-free alkaline earth salt solution, especially a magnesium salt solution, preferably a magnesium chloride solution.

4. Process for storage of a pH glass electrode (1) as claimed in claim 3, wherein the concentration of the ammonium chloride or ammonium nitrate solution, c(NH₄Cl) or c(NH₄NO₃), is between 0.1 mole/liter and saturated, preferably roughly 3 mole/l; and the concentration of the alkaline earth salt solution, especially the magnesium salt solution, preferably the magnesium chloride solution c(MgCl₂), is between 0.05 mole/l and saturated, preferably roughly 1.5 mole/l.

5. Use of an essentially alkali metal ion-free solution as a storage solution (3) for a pH glass electrode (1).

6. Use of an essentially alkali metal ion-free solution as claimed in claim 5, wherein an ammonium chloride or ammonium nitrate solution (NH₄Cl solution or NH₄NO₃ solution); or an alkaline earth salt solution, especially an alkaline earth chloride solution, preferably a magnesium salt solution, especially a magnesium chloride solution (MgCl₂ solution) is used.

7. Use of an essentially alkali metal ion-free solution as claimed in claim 5, an essentially alkali metal ion-free ammonium chloride or ammonium nitrate solution being used as the storage solution (3) for a combined pH glass electrode (1).

8. Use as claimed in claim 7, wherein the concentration of the ammonium chloride or ammonium nitrate solution, c(NH₄Cl) or c(NH₄NO₃), is between 0.1 mole/liter and saturated, preferably roughly 3 mole/l.

9. Use of an essentially alkali metal ion-free solution as claimed in claim 5, an essentially alkali metal ion-free alkaline earth salt solution, especially an alkaline earth chloride solution, preferably a magnesium salt solution, especially a magnesium chloride solution being used as the storage solution (3) for a separate pH glass electrode.

10. Use as claimed in claim 9, wherein the concentration of the alkaline earth salt solution, especially the magnesium chloride solution c(MgCl₂), is between 0.05 mole/liter and saturated, preferably roughly 1.5 mole/l.

11. System comprising the following:
a pH glass electrode (1); and
a storage solution (3) which is essentially free of alkali metal ions, especially an ammonium chloride or ammonium nitrate solution (NH₄Cl solution or a NH₄NO₃ solution); or an alkaline earth salt solution, especially an alkaline earth chloride solution, preferably a magnesium salt solution, especially a magnesium chloride solution (MgCl₂ solution); or the parent substance(s) for producing such a storage solution, especially ammonium chloride (NH₄Cl), ammonium nitrate (NH₄NO₃), or alkaline earth salt, especially a magnesium salt and/or alkaline earth chloride, preferably magnesium chloride (MgCl₂).

12. System as claimed in claim 11, comprising:
a combined pH glass electrode (1), especially with a preferably 3M potassium chloride solution (KCl solution) in the reference system; and
an ammonium chloride or ammonium nitrate solution (NH₄Cl solution or NH₄NO₃ solution); or solid ammonium chloride (NH₄Cl) or solid ammonium nitrate (NH₄NO₃) for producing such a solution.

13. System as claimed in claim 11, comprising:
a separate pH glass electrode (1), especially with a preferably 3M potassium chloride solution (KCl solution) in the reference system; and
an alkaline earth salt solution, especially an alkaline earth chloride solution, preferably a magnesium salt solution, especially a magnesium chloride solution (MgCl₂ solution); or solid alkaline earth salt, especially a solid alkaline earth chloride, preferably a magnesium salt, especially magnesium chloride (MgCl₂) for producing an alkaline earth salt solution, especially an alkaline earth chloride solution, preferably a magnesium chloride solution (MgCl₂ solution).
